(19) United States
(12) Patent Application Publication
(10) Pub. No.: US 2014/0232315 A1
(43) Pub. Date: Aug. 21, 2014

(54) METHOD AND SYSTEM FOR CONTROLLING INPUT VOLTAGE IN ELECTRIC CHARGES

(71) Applicants: Marcelo Zanelato, Joinville SC (BR); Marcos Roberto De Souza, Joinville SC (BR); Silvia Helena Pini, Joinville SC (BR)

(72) Inventors: Marcelo Zanelato, Joinville SC (BR); Marcos Roberto De Souza, Joinville SC (BR); Silvia Helena Pini, Joinville SC (BR)

(73) Assignee: WHIRLPOOL S.A., Sao Paulo (BR)

(21) Appl. No.: 14/122,508

(22) PCT Filed: May 24, 2012
(86) PCT No.: PCT/BR2012/000153

§ 371 Date: Apr. 17, 2014

(30) Foreign Application Priority Data
May 26, 2011 (BR) PI1102466-6

(51) Int. Cl. H02M 5/12

(52) U.S. Cl. CPC H02M 5/12
USPC 318/504; 323/301

(57) ABSTRACT

A method and a system for controlling input voltage (1) for electric charges (5) that have a selective organization of electric components for more than one input voltage (1), preferably for induction motors used on cooling compressors, by means of a set of output switches (4). The detection may be made either directly by means of a processing unit (3) or indirectly by means of a network sensor (6) capable of supplying information to the processing unit (3). Optionally, there is a protection sensor (7), as well as control reference values (8) capable of supplying information to the processing unit (3) for better protection of the electric charges (5).

The present invention relates to a method and a system for controlling input voltages for charges that have selective organization of electric components for more than one voltage, preferably for induction motors used on cooling compressors.

### DESCRIPTION OF THE PRIOR ART

At present, several countries diverge as to the production and distribution of electric energy, with different voltage levels in each country. Thus, the great majority of electronic apparatus, such as computers, television sets, stereos, among others, have a bi-voltage characteristic comprising an automatic voltage control that enables the adjustment of input voltages for its perfect functioning at specific voltages. This characteristic is still little known in the area of household appliances, because most of them need electric motors to function, being limited by present-day techniques due to factors like power and control, among others.

In this regard, the few of these products that enable functioning at bi-voltage have manual switching made by the final user by means of a switch, which usually modifies the organization of coils of the charges for its functioning. However, few users have specific knowledge for these functions, which often causes functional errors, as partial loss of functionality, or even blowing the product. Additionally, it may cause hazards to the user, depending on the level of protection of the apparatus.

In order to prevent these hazards, and increase the protection to the user and avoid unnecessary maintenance by guarantee services, thus decreasing losses in the image associated to the product manufacturer, the automatic changes in input voltage to the acceptable level of functioning of the apparatus become compulsory practice.

Analogously, single-phase induction motors are widely used on refrigerators by virtue of their simplicity, robustness and high performance. Specially applied in various household appliances like refrigerators, freezers, air conditioners, washing machines, among others, induction motors are usually provided with a cage-type rotor and a stator having coils that are usually composed of two windings, which are selectively used for the state (start or run) in which the induction motor is.

In this regard, during normal operation of the compressor a run winding is fed by an alternating voltage, while a start winding is only fed during the first moments of functioning of the motor, since the beginning of the movement need higher power for accelerating the motor. Therefore, motors are designed and built specifically to function at certain limited ranges of voltage, typically with variations not higher than 10% above and below the designed level. If these variations are higher than 10%, a new design and construction of the motor are required.

For this reason, possible attempts to solve this problem appear in documents that disclose bi-voltage systems. Document U.S. Pat. No. 4,415,964 describes a design in this sense, which provides a system capable of adjusting automatically the voltage output, regardless of the input voltage, modifying the organization of coils of an output transformer, upon altering the coils to a configuration in parallel, when it is turned on 110V, thus causing a 110V-output, and, in a contrary manner, altering the coils to a configuration in series when it is turned on 220V, thus repeating a 110V-output. However, in this construction the document limits possible charges to be fed, as well as the control over them, since it uses a transformer as the output, rather than the direct organization of the charges at which it is actuating.

Additional information that is considered in the prior art is presented in document U.S. Pat. No. 5,001,623, that describes a system for automatically controlling the voltage output with a direct-current, which, however, has the same problems as the above-mentioned document, and document U.S. Pat. No. 7,528,734, that describes a system that indicates the input voltage, capable of warning the user about whether the voltage present at that specific point is the desired one for the functioning of the apparatus, but without changing or controlling the output voltage.

It should be noted that all the documents presented are greatly susceptible of oscillation transients and other disturbances on the feed lines, besides presenting enormous consumption of energy and manufacture/maintenance costs, in comparison with the present invention.

### OBJECTIVES OF THE INVENTION

Thus, it is an objective of the present invention to provide a device for automatic voltage control, with simple and robust topology, in addition to reduced cost, which enables use on a large scale and reduction of models required for a given family of products for markets of different voltages.

It is another objective of this invention that the electronic control over these devices should have negligible consumption of energy.

A further objective of this invention is that the electronic control should be less susceptible to oscillation transients or disturbances from the feed network.

It is a further objective of this invention that the electronic control should be capable of adjusting induction motors or electric charges automatically and without the need to change of manual switches.

Another objective of this invention is to provide a specific organization capable of providing electronic protection of charges by monitoring the voltages applied to them, the currents and/or temperatures thereof.

Still another objective of this invention is to provide a specific system for integrated assembly of motors.

### BRIEF DESCRIPTION OF THE INVENTION

One first embodiment of the invention presents a system for controlling input voltage in electric charges, the electric charges having a coil arrangement that can be selectively actuated for operation at different levels of input voltage, the system comprising at least one processing unit and the a set of output switches. The processing unit is configured to detect the input voltage and to actuate on the set of output switches for carrying out the selective actuation of the electric charge, so that the electric charges will operate at the level of the input voltage detected by the processing unit. The system for controlling input voltage in charges may also comprise a network sensor that supplies the input-voltage values to the processing unit in a different configuration. Preferably, this system is configured to operate an inductive motor that comprises a set of claims that can be modified for actuation in series for the input voltage with value of 220V or in parallel for input voltage with value of 110V.

In another embodiment, the invention adds to the system for controlling input voltage in electric charges a protection sensor capable of supplying information on current, voltage and/or temperature to the processing unit. One should also consider an embodiment in which the system comprises a control reference unit capable of supplying references of current, voltage and/or temperature to the processing unit.

The invention also relates to a method for controlling input voltage ion electric charges, the electric charges having an arrangement of coils that can be selectively actuated for operation at different levels of input voltage, which comprises first step of detecting the input voltage and second step of actuating a set of output switches depending on the input voltage detected in the first step. Additionally, the method comprises a third step which modifies the arrangement of coils in the electric charges for operation at the level of input voltage detected in the first step. This method is also applied preferably for modifying the coil arrangements of an inductive motor, preferably actuating in series when the first step results in a value of 220V or in parallel when the first step results in a value of 110V.

Another method of controlling input voltage in electric charges presented is comprises a fourth step of detecting current, voltage and/or temperature of the electric charges for carrying out fifth step of protecting the electric charges, which prevents the functioning of the electric charges if the values detected in the first step are considered out of standard. The fourth step may further be configured so as to carry out the comparisons with respect to reference values established previously for specific states of the electric charges.

### BRIEF DESCRIPTION OF THE DRAWINGS

The present invention will now be described in greater detail with reference to an embodiment represented in the drawings. The figures show:

FIG. 1 is a representation of electric charges in organization in parallel;

FIG. 2 is a representation of electric charges in organization in series;

FIG. 3 is a block diagram representing the simplified system according to a preferred embodiment of the present invention;

FIG. 4 is a block diagram representing the simplified system of FIG. 3, with addition of a network sensor;

FIG. 5 is a block diagram representing the simplified system of FIG. 4, with addition of a protection sensor;

FIG. 6 is a block diagram representing the simplified system of FIG. 5, with addition of a control reference for better protection.

### DETAILED DESCRIPTION OF THE FIGURES

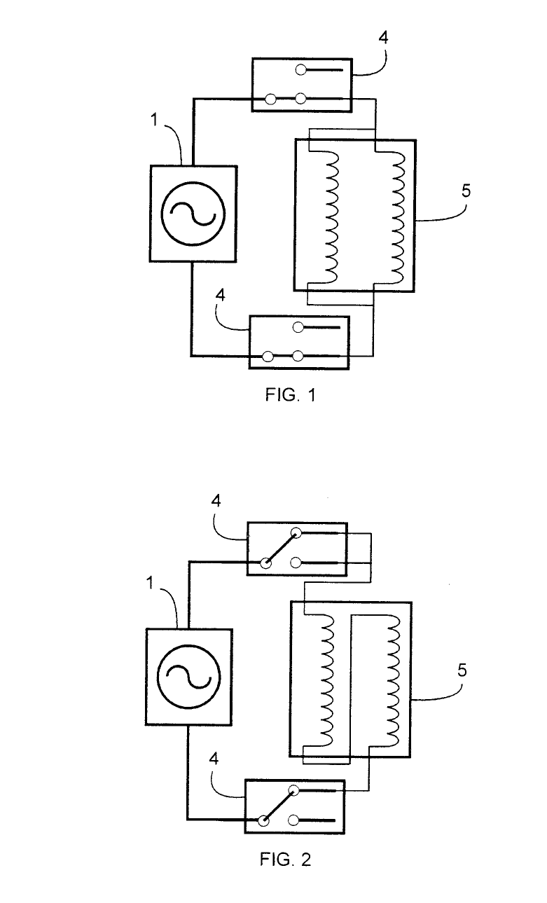

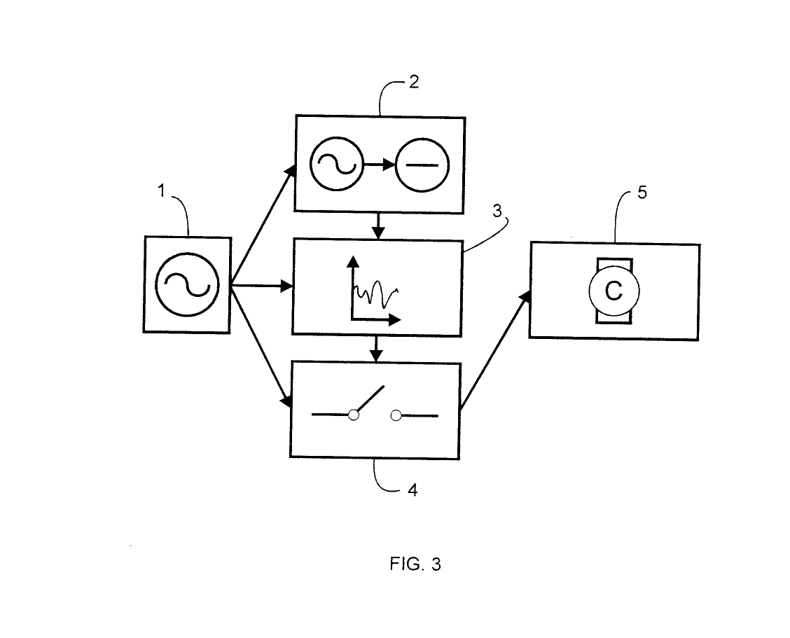

FIGS. 1 and 2 show electric charges 5 having elements that may be organized so as to be selectively actuated for operations at different voltages. FIG. 1 of this embodiment shows an organization of electric charges 5 in parallel, preferably for input voltage 1 with value of 110V, while FIG. 2 shows reversely an organization of electric charges 5 in series, preferably for input voltage 1 with value of 220V. It should be noted that the set of output switches 4 actuates directly in this organization of the electric charges 5.

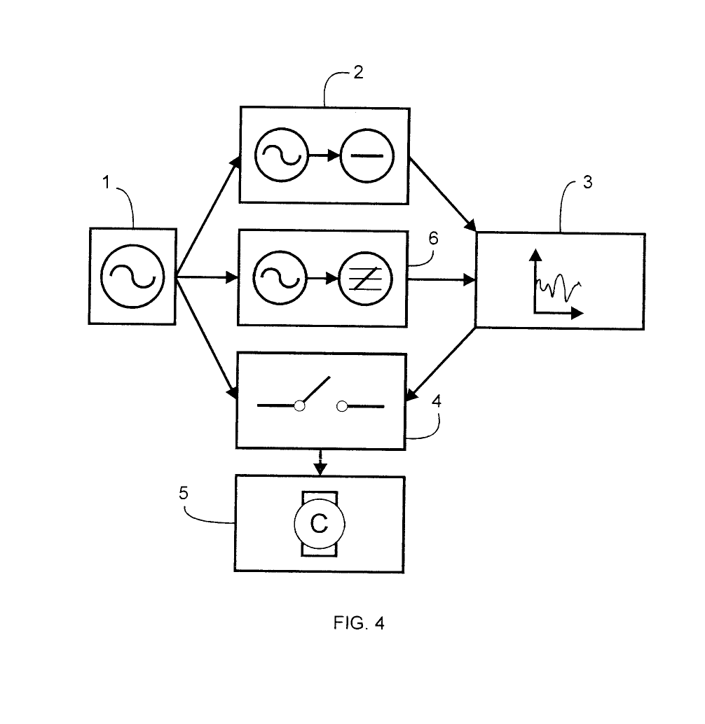

FIG. 3 illustrates the present invention, which provides a system for controlling voltages ion electric charges 5 that have elements, preferably a pair of coils of the same size, which can be organized so as to be selectively actuated for operations at different voltages, preferably in parallel for voltage 110V and in series for voltage 220V, as shown in FIGS. 1 and 2.

The electric charges 5, preferably used by this system, are single-phase induction motors, which comprise at least one stator having one or more run windings and one or more start windings, besides a rotor, preferably of the cage type. These induction motors may also be of the type of controlled variable velocity, in addition to others that were not cited but that can be built with the specified configurations.

In this regard, the system for controlling input voltage comprises an input voltage 1 that feeds a source of direct current 2 capable of supplying energy for the functioning of the processing unit 3, also fed by the input voltage 1, configured for detection of the dimensions of this input voltage 1 applied to the system. The detection of the system is made directly, the input voltage 1 being sent directly to the processing unit 3, which calculates and defines the voltage values.

Thus, the processing unit 3 is capable of actuating selectively on the set of output switches 4, which preferably comprise electromagnetic switches (such a relays or solenoids) or electronically controlled switches (such as static, TRIACs or transistors), also fed by the input voltage 1 and is capable of actuating so as to reconfigure the organization of the electric charges 5, so that the electric charges 5 will be better organized for the functioning at the input voltage 1 detected. Thus, the set of output switches 4 selects preferably an organization of coils in parallel for input voltages 1 of value 110V, while reversely selects an organization of coils in series for input voltages 1 of value 220V.

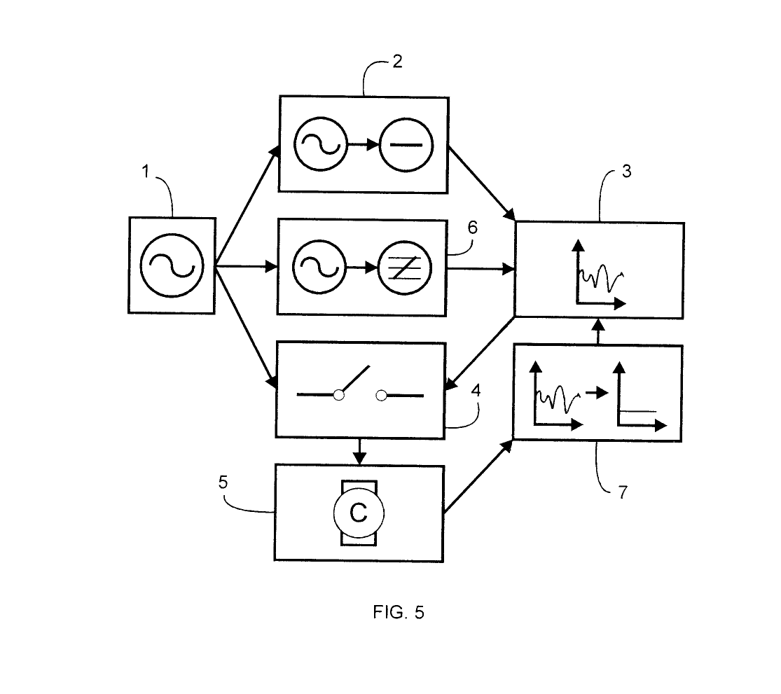

Analogously, FIG. 4 also presents a system that comprises an input voltage 1, which feeds a source of direct current 2. The source of direct current 2 is capable of supplying energy for the functioning of the processing unit 3. The system is characterized by an indirect detection of the input voltage 1, since the input voltage 1 also feeds a network sensor 6, which detects the dimensions of this input voltage 1 and supplies this information to the processing unit 3 for analysis, the processing unit 3 remaining responsible for the calculation and definition of input-voltage 1 values.

Thus, the processing unit 3 is capable of actuating selectively on the set of output switches 4, also fed by the input voltage 1. The set of output switches 4 is then capable of actuating so that the electric charges 5 will be better organized for the functioning at the input voltage 1 detected.

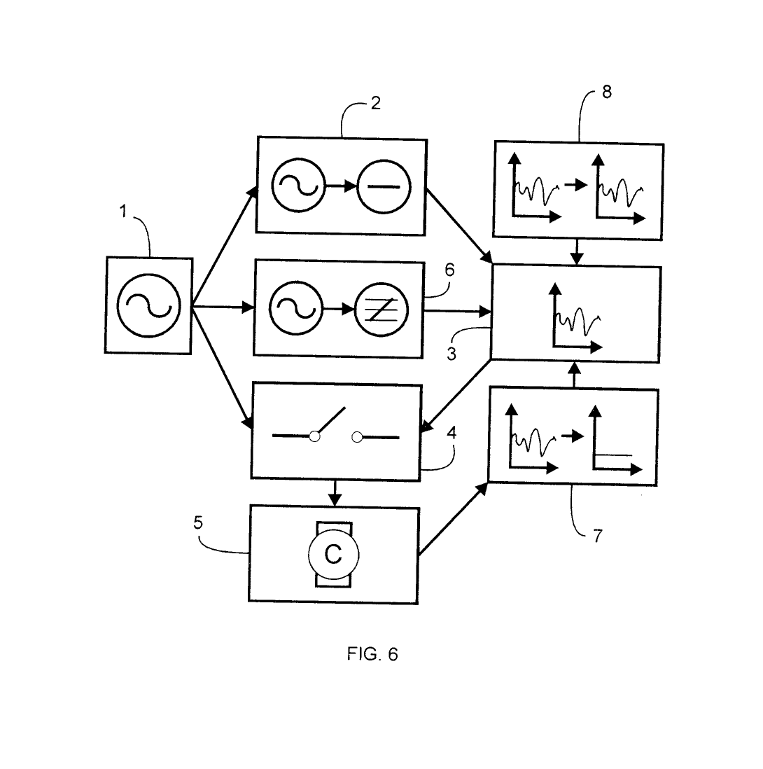

Similarly, FIG. 5 also presents a system comprising an input voltage 1, which feeds a source of direct current 2. The source of direct current 2 is capable of supplying energy for the functioning of the processing unit 3. The input voltage 1 also feeds a network sensor 6, which detects the dimensions of this voltage 1 and supplies this information to the processing unit 3. Thus, the processing unit 3 is capable of actuating selectively on the set of output switches 4, also fed by the input voltage 1. The set of output switches 4 is then capable of actuating so that the electric charges 5 will be better organized for the functioning at the voltage 1 detected. This system further comprises the addition of external devices and sensors that enable one to effect the electronic protection of apparatus, preferably by monitoring the voltage, current or temperature of the electric charges. These protection systems are connected to output and/or charges, being capable of actuating directly on the charges or communicating their data to the processing unit 3 for similar actuation. Thus, the present invention also comprises additional protection for the charges connected to the system. Therefore, this is a protection sensor 7, which receives the information on the electric charges 5 and supplies this information to the processing unit 3. The processing unit 3 is capable of actuating or turning of the set of switches 4 selectively by using the information supplied by the protection sensor 7 for greater protection of the electric charges 5.

In this regard, FIG. 6 shows also a system that comprises the input voltage 1, which feeds a source of direct current 2. The source of direct current 2 is capable of supplying energy for the functioning of the processing unit 3. The input voltage 1 also feeds a network sensor 6, which detects the dimensions of this input voltage 1 and supplies this information to the processing unit 3. Thus, the processing unit 3 is capable of actuating selectively on the set of output switches 4, also fed by the input voltage 1. The set of output switches 4 is then capable of actuating so that the electric charges 5 will be better organized for functioning at the input voltage 1 detected. This system further comprises a protection sensor 7, which receives information on the electric charges 5, this information consisting preferably of values of current, voltage and/or temperature, and supplies this information to the processing unit 3. The processing unit 3 is capable of actuating or turning of the set of switches 4 selectively by using the information supplied by the protection sensor 7 for protection of the electric charges 5. This configuration also presents addition of reference values, which may be memories or the like, so that the processing unit 3 can relate the values supplied by the protection sensor 7 to the reference values, carrying out functions required for better protection of the charges. In this way, the control reference 8 supplies data for the processing unit 3 to effect better protection of the electric charges 5 by comparing the reference control values 8 with the values supplied by the protection sensor 7.

It should be noted that only FIG. 3 maintains direct sensing of the input voltage to the processor, but all the configurations are likely to be used in both directly and indirectly modes.

A preferred embodiment having been described, one should understand that the scope of the present invention embraces other possible variations, being limited only by the contents of the accompanying claims, which include the possible equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A system for controlling input voltage (1) in electric charges (5), the electric charges (5) comprising an arrangement of coils that are selectively actuated for operation at different levels of input voltage (1), the system comprising at least:
one processing unit (3) and
a set of output switches (4),
wherein the processing unit (3) is configured for detecting the input voltage (1) and actuating the set of output switches (4) to selectively modify the arrangement of the coils in the electric charges (5), so that the electric charge (5) will operate at the input voltage level (1) detected by the processing unit (3), the system further comprising:
a protection sensor (7) capable of supplying values with information on at least one of current, voltage and temperature to the processing unit (3); and
a control reference unit (8) capable of supplying references of at least one of current, voltage and temperature to the processing unit (3), the reference control values being compared to values supplied by the protection sensor (7) for protection of the electric charges (5).

14. A system for controlling input voltage (1) in electric charges (5) according to claim 13, further comprising a network sensor (6) that supplies the level of input voltage (1) to the processing unit (3).

15. A system for controlling input voltage (1) in electric charges (5) according to claim 13, wherein the system is configured to operate an inductive motor.

16. A system for controlling input voltage (1) in electric charges (5) according to claim 15, wherein the inductive motor comprises a set of coils capable of being modified for actuation in series for input voltage (1) with a value of 220V or in parallel for input voltage (1) with a value of 110V.

17. A system for controlling input voltage (1) in electric charges (5) according to claim 14, wherein the system is configured to operate an inductive motor.

18. A method for controlling input voltage (1) in electric charges (5), the electric charges (5) having an arrangement of coils that can be selectively actuated for operation at different levels of input voltage (1), which comprises the steps of:
Step 1: detecting the input voltage (1);
Step 2: actuating the set of output switches (4), as a function of the input voltage (1) detected in Step 1;
Step 3: modifying the arrangement of coils in the electric charges (5), for operation at the level of input voltage (1) detected by the Step 1.

19. A method for controlling input voltage (1) in electric charges (5) according to claim 18, wherein Step 1 of detecting the values of input voltage (1) is carried out by a network sensor (6).

20. A method for controlling input voltage (1) in electric charges (5) according to claim 18, wherein Step 3 of modifying the arrangements of coils is applied to an inductive motor.

21. A method for controlling input voltage (1) in electric charges (5) according to claim 20, wherein Step (3) modifies the organization of coils of the inductive motor for actuation in series when the Step 1 of detecting input voltage (1) results in a value of 220V or modifies the organization of coils of the inductive motor for actuation in parallel when the Step 1 of detecting input voltage (1) results in a value of 110V.

22. A method of controlling input voltage (1) in electric charges (5) according to claim 18, further comprising:
Step 4: detecting at least one of current, voltage and temperature of the electric charges (5);
Step 5: protecting the electric charges (5), which prevents the functioning of the electric charges (5) if the values detected in Step 4 are capable of damaging the electric charges (5).

23. A method of controlling input voltage (1) in electric charges (5) according to claim 22, wherein Step 5 compares the values obtained by Step 4 with previously established reference values of the electric charges (5), protecting the system if the values detected in Step 4 are capable of damaging the electric charges (5) when compared with the reference values.

24. A method for controlling input voltage (1) in electric charges (5) according to claim 19, wherein Step 3 of modifying the arrangements of coils is applied to an inductive motor.

25. A method of controlling input voltage (1) in electric charges (5) according to claim 19, further comprising:
Step 4: detecting at least one of current, voltage and temperature of the electric charges (5);
Step 5: protecting the electric charges (5), which prevents the functioning of the electric charges (5) if the values detected in Step 4 are capable of damaging the electric charges (5).

26. A method of controlling input voltage (1) in electric charges (5) according to claim 20, further comprising:
Step 4: detecting at least one of current, voltage and temperature of the electric charges (5);
Step 5: protecting the electric charges (5), which prevents the functioning of the electric charges (5) if the values detected in Step 4 are capable of damaging the electric charges (5).

27. A method of controlling input voltage (1) in electric charges (5) according to claim 21, further comprising:
Step 4: detecting at least one of current, voltage and temperature of the electric charges (5);
Step 5: protecting the electric charges (5), which prevents the functioning of the electric charges (5) if the values detected in Step 4 are capable of damaging the electric charges (5).
